(19) United States
(12) Patent Application Publication
(10) Pub. No.: US 2020/0201065 A1
(43) Pub. Date: Jun. 25, 2020

(54) DISPLAY DEVICE, OPTICAL SYSTEM AND VIRTUAL REALITY HEAD-MOUNTED DISPLAY DEVICE

(71) Applicants: Beijing BOE Optoelectronics Technology Co., Ltd., Beijing (CN); BOE TECHNOLOGY GROUP CO., LTD., Beijing (CN)

(72) Inventors: Xuebing Zhang, Beijing (CN); Guobing Yin, Beijing (CN); Ruijun Dong, Beijing (CN); Chenru Wang, Beijing (CN); Yali Liu, Beijing (CN); Ke Li, Beijing (CN); Hao Zhang, Beijing (CN); Lili Chen, Beijing (CN)

(21) Appl. No.: 16/613,069

(22) PCT Filed: Apr. 16, 2019
(86) PCT No.: PCT/CN2019/082940

§ 371 Date: Nov. 12, 2019

(30) Foreign Application Priority Data
Apr. 28, 2018 (CN) 201820629481.6

(51) Int. Cl. G02B 30/25; G02F 1/1335; G02F 1/1343; G02F 1/01; H04N 13/337

(52) U.S. Cl. CPC G02B 30/25; G02F 1/133528; G02B 27/283; G02F 1/0136; H04N 13/337; G02F 1/13439

(57) ABSTRACT

The present disclosure provides a display device, an optical system, and a virtual reality head-mounted display device. The display device includes a display part, which can emit image light for forming an image from a light emission surface of the display part. The display device includes a polarization modulation part. The polarization modulation part is arranged on the light emission surface of the display part, and can receive the image light emitted from the display part, and be controlled in a time division multiplexing manner to modulate the image light emitted from the display part to generate at least two types of modulated light in a form of polarized light having different polarization directions.

### CROSS-REFERENCE

This application claims is based upon International Application No. PCT/CN2019/082940, filed on Apr. 16, 2019, which is based upon and claims priority to Chinese Utility Model Patent Application No. 201820629481.6, filed on Apr. 28, 2018, titled “DISPLAY DEVICE, OPTICAL SYSTEM, AND VIRTUAL REALITY HEAD-MOUNTED DISPLAY DEVICE”, and the entire contents thereof are incorporated herein by reference.

### TECHNICAL FIELD

The present disclosure generally relates to the field of display technologies, and more particularly, to a display device, an optical system, and a virtual reality head-mounted display device.

### BACKGROUND

Virtual Reality (VR) technologies have been rapidly developed in recent years, and have been widely used in military simulation, visual simulation, virtual manufacturing, virtual design, virtual assembly, scientific visualization, etc., bringing people great help and enjoyment in learning, living, working, entertainment, etc.

As an implementation of virtual reality, stereoscopic display technologies use a series of optical methods to generate parallax between human left and right eyes to receive different images. After two different images are delivered to brain, an image with depth of field is obtained, thus forming a stereoscopic effect in the brain.

The above-mentioned information disclosed in this Background section is only for the purpose of enhancing the understanding of background of the present disclosure and may therefore include information that does not constitute a prior art that is known to those of ordinary skill in the art.

### SUMMARY

This part of the present disclosure is intended to provide a simplified summary of contents disclosed in this application, such that readers have a basic understanding of the contents disclosed in this application. Contents of this part of the present disclosure are not complete descriptions of the contents disclosed in this application and are not intended to indicate key/critical elements of arrangements of this application or define the scope of protection of this application.

According to an aspect of the present disclosure, there is provided a display device. The display device includes a display part configured to emit image light for forming an image from a light emission surface of the display part. The display device includes a polarization modulation part arranged on the light emission surface of the display part. The polarization modulation part is configured to receive the image light emitted from the display part, and be controlled in a time division multiplexing manner to modulate the image light emitted from the display part to generate at least two types of modulated light in a form of polarized light having different polarization directions.

According to an arrangement, the modulated light may be linearly polarized light. The modulated light includes left-circularly or elliptically polarized light and right-circularly or elliptically polarized light.

According to an arrangement, the modulated light may include first modulated light having a first polarization direction and second modulated light having a second polarization direction.

According to an arrangement, the display part may be a liquid crystal display device or a liquid crystal on silicon display device, and the image light emitted from the display part may be polarized light having a first polarization direction.

According to a further arrangement, the polarization modulation part may include a first transparent electrode, a second transparent electrode, and a liquid crystal layer sandwiched between the first transparent electrode and the second transparent electrode. The first transparent electrode is arranged on the light emission surface of the display part.

According to a further arrangement, the polarization modulation part may be configured to form the first modulated light having the first polarization direction or second modulated light having a second polarization direction according to a fact whether a voltage is applied to the liquid crystal layer. The second polarization direction is different from the first polarization direction. Particularly, when neither the first transparent electrode nor the second transparent electrode applies a voltage to the liquid crystal layer, the image light having the first polarization direction emitted by the liquid crystal display part transmits through the polarization modulation part without changing the polarization direction to form the first modulated light having the first polarization direction. When a voltage is applied to the liquid crystal layer via the first transparent electrode and the second transparent electrode, the polarization modulation part modulates the image light having the first polarization direction emitted by the display part into the second modulated light having the second polarization direction. Alternatively, when a voltage is applied to the liquid crystal layer via the first transparent electrode and the second transparent electrode, the polarization modulation part may be configured to form the first modulated light having the first polarization direction such that the image light having the first polarization direction emitted by the liquid crystal display part transmits through the polarization modulation part without changing the polarization direction. When neither the first transparent electrode nor the second transparent electrode applies a voltage to the liquid crystal layer, the polarization modulation part modulates the image light having the first polarization direction emitted by the liquid crystal display part into the second modulated light having the second polarization direction.

According to an arrangement, the display part may be a plasma display device or an organic electroluminescence display device or a digital mirror device.

According to a further arrangement, the polarization modulation part may include a polarizer, a first transparent electrode arranged on the polarizer, a second transparent electrode, and a liquid crystal layer sandwiched between the first transparent electrode and the second transparent electrode. The polarizer is arranged on the light emission surface of the liquid crystal display part, and is configured to modulate the image light emitted from the light emission surface of the display part into first modulated light in the form of polarized light having a first polarization direction.

The polarization modulation part is configured to form the first modulated light having the first polarization direction or second modulated light having a second polarization direction according to a fact whether a voltage is applied to the liquid crystal layer, and the second polarization direction is different from the first polarization direction. Particularly, when neither the first transparent electrode nor the second transparent electrode applies a voltage to the liquid crystal layer, the image light having the first polarization direction emitted by the liquid crystal display part transmits through the polarization modulation part without changing the polarization direction to form the first modulated light having the first polarization direction. When a voltage is applied to the liquid crystal layer via the first transparent electrode and the second transparent electrode, the polarization modulation part modulates the image light having the first polarization direction emitted by the liquid crystal display part into the second modulated light having the second polarization direction. Alternatively, when a voltage is applied to the liquid crystal layer via the first transparent electrode and the second transparent electrode, the polarization modulation part may be configured to form the first modulated light having the first polarization direction such that the image light having the first polarization direction emitted by the liquid crystal display part transmits through the polarization modulation part without changing the polarization direction. When neither the first transparent electrode nor the second transparent electrode applies a voltage to the liquid crystal layer, the polarization modulation part modulates the image light having the first polarization direction emitted by the liquid crystal display part into the second modulated light having the second polarization direction.

According to another aspect of the present disclosure, there is provided an optical system. The optical system includes the above display device. The optical system further includes a polarization beam splitter, which can receive modulated light emitted from the polarization modulation part, and allow the modulated light having different polarization directions to emit from the polarization beam splitter along different light paths to form path light.

According to an arrangement, the polarized light may include first modulated light having a first polarization direction and second modulated light having a second polarization direction, and the first polarization direction may be vertical to the second polarization direction.

According to an arrangement, the polarization beam splitter includes a polarization beam splitter prism, which can allow the first modulated light reflected to be emitted from the polarization beam splitter prism to form first path light, and allow the second modulated light to transmit through the polarization beam splitter prism to form second path light.

According to an arrangement, the optical system further includes a reflecting part, which can receive and reflect one of the first path light and the second path light, such that the reflected path light is parallel to the other one of the first path light and the second path light.

According to still another aspect of the present disclosure, there is provided a virtual reality display device. The virtual reality display device may include the above optical system. The polarization modulation part is controlled in a time division multiplexing manner, such that the display device alternately emits first polarized light having a first polarization direction and second polarized light having a second polarization direction. The first polarization direction is different from the second polarization direction. The virtual reality head-mounted display device may further include a first imaging lens and a second imaging lens. The first imaging lens and the second imaging lens are configured to respectively receive the first path light and the second path light, and alternately image the first path light and the second path light into a left eye and a right eye of a wearer wearing the virtual reality head-mounted display device, respectively.

According to an arrangement, the optical system further includes a reflecting part, which can receive and reflect one of the first path light and the second path light, such that the reflected path light is parallel to the other one of the first path light and the second path light, and is incident on one of the first imaging lens and the second imaging lens.

According to an arrangement, a focal length of the first imaging lens and a focal length of the second imaging lens are adjusted according to an optical length from the display device to the first imaging lens and an optical length from the display device to the second imaging lens. The focal length of the first imaging lens may be greater than that of the second imaging lens when the optical length from the display device to the first imaging lens is larger than the optical length from the display device to the second imaging lens. The focal length of the first imaging lens may be equal to that of the second imaging lens when the optical length from the display device to the first imaging lens is equal to the optical length from the display device to the second imaging lens. The focal length of the second imaging lens may be greater than that of the first imaging lens when the optical length from the display device to the second imaging lens is larger than the optical length from the display device to the first imaging lens.

### BRIEF DESCRIPTION OF THE DRAWINGS

The accompanying drawings of this application are incorporated in and constitute a part of this specification, illustrate a part of arrangements conforming to the present disclosure and, together with the description, serve to explain the principles of the present disclosure.

FIG. 1 is a schematic stereoscopic display diagram of a polarization display device;

FIG. 2 is a schematic section vies of a display device according to an arrangement of the present disclosure;

FIG. 3 is a schematic structural diagram of an optical structure according to an arrangement of the present disclosure; and

FIG. 4 is a schematic structural diagram of an optical structure according to another arrangement of the present disclosure.

### DETAILED DESCRIPTION

Example arrangements of the present disclosure will now be described more fully with reference to the accompanying drawings. However, the present disclosure can be implemented in a variety of forms and should not be construed as being limited to the example arrangements specifically set forth in the description. However, these example arrangements are provided so that the present disclosure will be more thoroughly and completely disclosed and the concepts of the present disclosure will be fully conveyed to those skilled in the art.

The accompanying drawings of this application are merely example. Structures or features shown in the accompanying drawings may be exaggerated and may be not drawn to scale so as to clearly explain the principles of the present disclosure.

The same reference numerals in the accompanying drawings denote the same or similar parts, and thus repeated description thereof will be omitted.

It is to be noted that terms of orientation used in describing the arrangements disclosed in this application, such as “upper”, “lower”, and so on, merely refer to the orientations as shown in the accompanying drawings and do not represent orientations in real use environments.

In addition, in this application, unless otherwise stated, nouns do not represent or imply specific numbers, which may represent one or two or more. The quantifier “a plurality of” represents two or more, which includes this number.

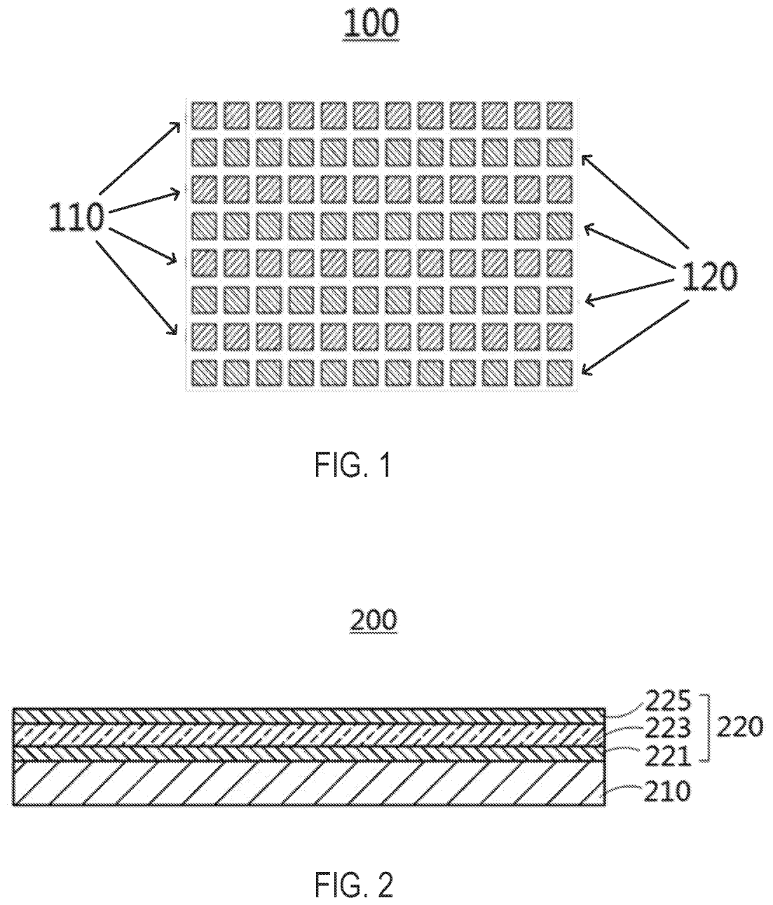

FIG. 1 schematically illustrates a schematic stereoscopic display diagram. As shown in FIG. 1, the display device 100 is a polarization display device, and in general, light emitted from the display device 100 is linearly polarized light. The polarization display device 100 typically is a liquid crystal display device. The exiting light from odd-numbered rows (or odd-numbered columns) of pixels 110 of the polarization display device 100 has a first polarization direction. The exiting light from even-numbered rows (or even-numbered columns) of pixels 120 of the polarization display device 100 has a second polarization direction. The first polarization direction and the second polarization direction are orthogonal to each other. The odd-numbered rows (or odd-numbered columns) of pixels constitute one picture, and the even-numbered rows (or even-numbered columns) of pixels constitute another picture. The two pictures may be seen by a left eye and a right eye respectively, thus forming a left-eye image and a right-eye image. Because the left-eye image and the right-eye image need to be displayed at the same time, the resolution of the picture actually viewed by a viewer is reduced by half compared with that of the display screen of the polarization display device 100, and the brightness thereof is also reduced by half, making it difficult to realize a real high-definition 3D image.

The technical idea of the present disclosure is described below with reference to FIG. 2 to FIG. 4.

FIG. 2 is a schematic section vies of a display device according to an arrangement of the present disclosure. In the illustrated arrangement, the display device 200 includes a display part 210 and a polarization modulation part 220. The polarization modulation part 220 is arranged on a light emission surface of the display part 210, is configured to receive image light emitted from the display part 210, and can be controlled to modulate the image light emitted from the display part 210 to generate at least two types of modulated light in a time division multiplexing manner. In this application, the “modulated light” refers to exiting light transmitted from the polarization modulation part. In this application, the modulated light is polarized light, which may be linearly polarized light. In this case, the modulated light has different polarization directions. Alternatively, the modulated light also may be circularly or elliptically polarized light. In this case, the modulated light may be left-handed polarized light and right-handed polarized light.

The present disclosure does not limit the display structure or the display principle of the display part itself, and thus, various display parts may be applied to the present disclosure. The display part 210 may be a liquid crystal display device or a liquid crystal on silicon display device, or may be a plasma display device or an organic electroluminescence display device or a digital mirror device. Image light emitted from the liquid crystal display device or the liquid crystal on silicon display device generally is linearly polarized light or left-handed or right-handed polarized light. However, image light emitted from the plasma display device or the electroluminescence display device or the digital mirror device generally is not linearly polarized light. In this application, the “image light” refers to light emitted from a display part, and contains image information.

In the following description of a specific arrangement, a liquid crystal type display part 210 is used, and image light emitted from the liquid crystal type device 210 is linearly polarized light having a first polarization direction.

According to an arrangement of the present disclosure, the display part 210 is a liquid crystal display part, and image light emitted from a light emission surface of the display part 210 is linearly polarized light having a first polarization direction. The polarization modulation part 220 may be of a liquid crystal cell type structure, including a first transparent electrode 221, a second transparent electrode 225, and a liquid crystal layer 223 sandwiched between the two electrodes. Materials of the first electrode 221 and the second electrode 225 may be, for example, indium tin oxide (ITO). The first electrode 221 may be formed on a first substrate of a material such as transparent glass by electroplating or sputtering process, and the second electrode 225 may be formed on a second substrate of a material such as transparent glass by a similar or the same process. Next, the first substrate and the second substrate are formed into a liquid crystal cell structure. Both the first electrode and the second electrode are formed on inner surfaces of the two substrates. Next, liquid crystal is injected into space between the two substrates to form the liquid crystal layer 223. Finally, such a separate liquid crystal cell type polarization modulation part 220 is bonded onto the light emission surface of the display part 210.

As an alternative, the first substrate may be glass where the light emission surface of the display part 210 is located, or the first electrode may be directly formed on the glass where the light emission surface of the display part 210 is located. Therefore, the liquid crystal cell type polarization modulation part is integrated with the display part.

Numerous liquid crystal materials that are currently in practical use have calamitic molecules. A unit vector in parallel with an average direction of long axes of adjacent molecules is a direction vector. Nematic liquid crystal is the most widely used in liquid crystal display devices. In a nematic phase, all molecules are only substantially parallel to each other, one-dimensional ordered but positional disorder. The nematic liquid crystal is prone to reorientation, rearrangement or deformation by externally applied mechanical stresses, electric fields or magnetic fields, or by contact with a properly treated surface. For example, the inner surface of the first substrate and the inner surface of the second substrate may be rubbed, such that liquid crystal molecules form a homogeneous alignment in parallel with a surface at a boundary. A director of the liquid crystal molecules on the inner surface of the first substrate is restricted in a first direction that is the same as the first polarization direction of the image light emitted from the liquid crystal display part, and a director of the liquid crystal molecules on the inner surface of the second substrate is restricted in a second direction that is different from the first polarization direction. For example, the first direction and the second direction may be orthogonal to each other. Thus, the liquid crystal layer 223 is formed into a twisted nematic structure. When the injected liquid crystal is positive nematic liquid crystal, the director of the liquid crystal is uniformly twisted from an upper surface to a lower surface in the case where no voltage is applied, and the incident image light having the first polarization direction is changed from the first polarization direction to the second polarization direction after it is emitted through the liquid crystal layer 223. That is, the modulated light has a second polarization direction. When a voltage is applied to the liquid crystal layer 223 through the first electrode 221 and the second electrode 225, the director of the liquid crystal molecules is aligned in the direction of the electric field, and the uniformly twisted structure disappears. The incident image light having the first polarization direction is not changed in polarization direction after it is emitted through the liquid crystal layer 223. That is, the modulated light has a first polarization direction.

As an alternative, if the liquid crystal layer 223 is made from a negative liquid crystal material, when a voltage is applied to the liquid crystal layer 223 through the first electrode 221 and the second electrode 225, the image light having the first polarization direction is changed into modulated light having the second polarization direction after it is emitted through the liquid crystal layer 223. When no voltage is applied to the liquid crystal layer 223, after the image light having the first polarization direction is emitted through the liquid crystal layer 223, the modulated light is still linearly polarized light having the first polarization direction.

The structure and basic principles of the polarization modulation part of the present disclosure have been described above by way of example. In accordance with the teachings above, those skilled in the art should appreciate that a variety of known liquid crystal display or light-valving structures in the related art may be directly used as the polarization modulation part of the present disclosure, or indirectly used as the polarization modulation part of the present disclosure after appropriate modifications are made.

For the display device 200 according to an arrangement of the present disclosure described above, by applying a voltage having a predetermined waveform or duty ratio through the first electrode 221 and the second electrode 225, the image light emitted from the display part 210 may be changed into modulated light whose first polarization direction and second polarization direction alternately vary with time according to a voltage waveform after the image light is emitted from the polarization modulation part 220.

Those skilled in the art may appreciate that by designing parameters such as the thickness of the liquid crystal layer, the directors of the upper and lower surfaces of the liquid crystal layer, the incident linearly polarized light may be converted into left-circularly or elliptically polarized light and right-circularly or elliptically polarized light.

In another arrangement of the present disclosure, the display part may be a plasma display device or an organic electroluminescence display device or a digital mirror device, etc. In this case, the image light emitted from the display part is not polarized light. In this arrangement, the polarization modulation part also includes a polarizer in addition to the first electrode, the second electrode, and the liquid crystal layer described above. The polarizer is positioned between the first electrode and the light emission surface of the display part, and may be integrally formed with the light emission surface of the display part, or may be integrally formed with a glass substrate of the first electrode. Similar to the display part 200 described above with reference to FIG. 2, for the display part according to this arrangement, by applying a voltage having a predetermined waveform or duty ratio through the first electrode and the second electrode, the image light emitted from the display part may be changed into modulated light whose first polarization direction and second polarization direction alternately vary with time according to a voltage waveform after the image light is emitted from the polarization modulation part.

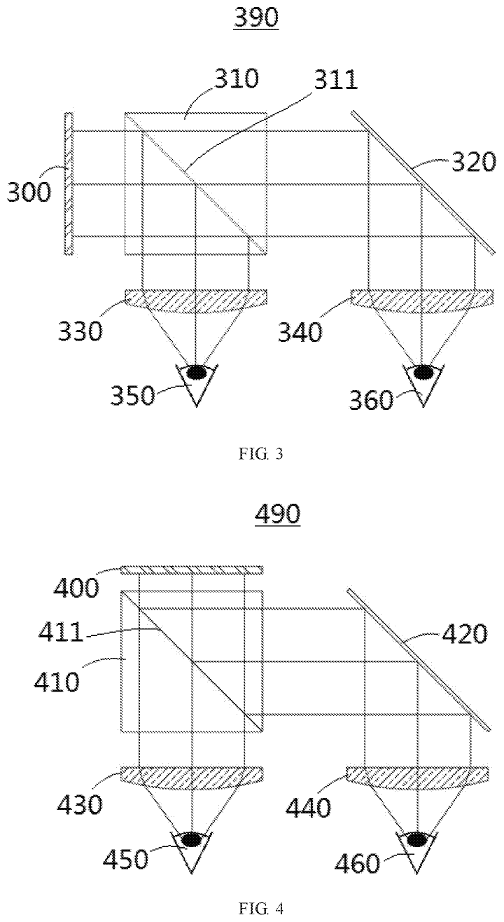

FIG. 3 and FIG. 4 schematically illustrate two arrangements of an optical system that may be used in a virtual reality display device such as the virtual reality head-mounted display device according to the present disclosure.

The optical system 390 according to the arrangement as shown in FIG. 3 includes a display device 300. The display device 300 may be any of the display device described in the above arrangements. Therefore, modulated light having different polarization directions or states is emitted from the display device 300. For example, the modulated light may include first modulated light and second modulated light, the first modulated light is linearly polarized light having a first polarization direction, and the second modulated light is linearly polarized light having a second polarization direction. The first polarization direction may be orthogonal to the second polarization direction.

Those skilled in the art should appreciate that modulated light in other polarization states such as elliptic polarization or circular polarization is also applicable to the optical system of the present disclosure.

The optical system 390 of this arrangement also includes a polarization beam splitter 310. The polarization beam splitter 310 can receive modulated light emitted from the polarization modulation part of the display device 300, and allow the modulated light having different polarization directions to emit from the polarization beam splitter 310 along different light paths to form path light. The polarization beam splitter 310 may be, for example, a polarization splitting prism. The polarization splitting prism is a cubic structure formed by adhesion bonding after an optical medium layer having a multilayer film structure is coated on an inclined plane of a right-angle prism. The property of the multilayer film structure is as below: when light is incident at Brewster's angle, the transmittance of polarized light (for example, P-polarized light) in a certain polarization state is equal to 1, whereas the transmittance of polarized light (for example, S-polarized light) in another polarization state is less than 1. After the light penetrates through the multilayer film structure at the Brewster's angle for many times, a P-polarization component is transmitted through the prism, whereas an S-polarization component is reflected through the prism.

Those skilled in the art may appreciate that a variety of devices that can transmit or reflect incident light by a polarization state of the incident light may be used as the polarization beam splitter of the present disclosure, for example, a polarization splitting prism.

With continued reference to FIG. 3, the first modulated light and the second modulated light whose polarization directions are orthogonal to each other are incident on an optical medium layer 311 of the polarization beam splitter 310, such that the first modulated light having the first polarization direction is reflected to be emitted from the polarization beam splitter 310 to form first path light, and that the second modulated light having the second polarization direction is transmitted through the polarization beam splitter 310 to form second path light. In this application, “path light” refers to light having different paths that is split by the polarization beam splitter such as the polarization splitting prism.

The optical system 390 in this arrangement also includes a reflecting part 320. The reflecting part 320 may be, for example, a retroreflector. Various reflecting parts known in the art may be used in the present disclosure. The reflecting part 320 can receive and reflect one of the first path light and the second path light, such that the reflected path light is parallel to the other one of the first path light and the second path light. For example, the reflecting part 320 may be arranged on the light path of the second path light directly transmitted from the polarization beam splitter 310, such that the second path light is changed to be parallel to the first path light reflected from the polarization beam splitter 10.

The optical system 390 as shown in FIG. 3 further includes a first imaging lens 330 and a second imaging lens 340. In an application of the virtual reality head-mounted display device, the first imaging lens 330 receives the first path light and converges it into a wearer's left eye 350 to form a left-eye image, and the second imaging lens 340 receives the second path light and converges it into the wearer's right eye 360 to form a right-eye image.

As mentioned above, for the display device 300 according to the present disclosure, by applying a voltage having a predetermined waveform or duty ratio through the first electrode and the second electrode, the image light emitted from the display device may be changed into modulated light whose first polarization direction and second polarization direction alternately vary with time according to a voltage waveform after the image light is emitted from the polarization modulation part. In particular, in an application of the virtual reality head-mounted display device, the first electrode and the second electrode may be driven using a time division multiplexing technology, such that the left eye and the right eye of the wearer alternately see the left-eye image and the right-eye image. By using the persistence of vision and the parallax between the left-eye image and the right-eye image in different polarization directions, an image with depth of field is formed in the wearer's brain, thus forming a stereoscopic effect in the wearer's brain.

In the arrangement as shown in FIG. 3, the optical length from the time division multiplexing polarization display device 300 to the first imaging lens 330 is different from the optical length from the display device 300 to the second imaging lens 340. In order to make sure that the left-eye image and the right-eye image respectively projected into the left eye 350 and the right eye 360 have the same imaging distance, the first imaging lens 330 and the second imaging lens 340 may be designed to have different focal lengths. In the case illustrated, the optical length from the time division multiplexing polarization display device 300 to the second imaging lens 340 is larger than the optical length from the display device 300 to the first imaging lens 330, and thus the focal length of the second imaging lens 340 may be greater than that of the first imaging lens 330.

In addition, in order to further improve the stereoscopic display quality, the display frame frequency of the time division multiplexing polarization display device 300 may be at least twice an ordinary polarization display frame frequency. Thus, resolutions of the time division multiplexing polarization display device and the virtual reality head-mounted display device according to the present disclosure are doubled as compared with related existing stereoscopic display device in the case where the brightness is constant.

FIG. 4 is another arrangement of an optical system that may be used in the virtual reality head-mounted display device according to the present disclosure. An optical device substantially the same as shown in FIG. 3 is used in the arrangement as shown in FIG. 4, except that light paths are different.

The optical system 490 according to the arrangement as shown in FIG. 4 includes a display device 400. Like the display device 300 in FIG. 3, the display device 400 may be any of the display device described in the above arrangements. Therefore, modulated light having different polarization directions or states is emitted from the display device 400. For example, the modulated light may include first modulated light and second modulated light, the first modulated light is linearly polarized light having a first polarization direction, and the second modulated light is linearly polarized light having a second polarization direction. The first polarization direction may be orthogonal to the second polarization direction.

The optical system 490 of this arrangement also includes a polarization beam splitter 410 and a reflecting part 420 the same as those in the arrangement as shown in FIG. 3. The polarization beam splitter 410 can receive modulated light emitted from the polarization modulation part of the display device 400, and allow the modulated light having different polarization directions to emit from the polarization beam splitter 410 along different light paths to form path light. The polarization beam splitter 410 may be, for example, a polarization splitting prism.

With continued reference to FIG. 4, the first modulated light and the second modulated light whose polarization directions are orthogonal to each other are incident on an optical medium layer 411 of the polarization splitting prism 410, such that the first modulated light having the first polarization direction is reflected to be emitted from the polarization splitting prism 410 to form first path light, and that the second modulated light having the second polarization direction is transmitted through the polarization splitting prism 410 to form second path light.

The reflecting part 420 may be arranged on the light path of the first path light reflected from the polarization splitting prism 410, such that the first path light is changed to be parallel to the first path light directly transmitted from the polarization splitting prism 410.

The first imaging lens 430 receives the first path light and converges it into a wearer's left eye 350 to form a left-eye image, and the second imaging lens 340 receives the second path light and converges it into the wearer's right eye 360 to form a right-eye image.

In the case illustrated, the optical length from the time division multiplexing polarization display device 400 to the second imaging lens 440 is larger than the optical length from the display device 400 to the first imaging lens 430, and thus the focal length of the second imaging lens 440 may be greater than that of the first imaging lens 430.

Similarly, for the display device 400 according to the present disclosure, by applying a voltage having a predetermined waveform or duty ratio through the first electrode and the second electrode, the image light emitted from the display part may be changed into modulated light whose first polarization direction and second polarization direction alternately vary with time according to a voltage waveform after the image light is emitted from the polarization modulation part. In particular, in an application of the virtual reality head-mounted display device, the first electrode and the second electrode may be driven using a time division multiplexing technology, such that the left eye and the right eye of the wearer alternately see the left-eye image and the right-eye image. By using the persistence of vision and the parallax between the left-eye image and the right-eye image in different polarization directions, an image with depth of field is formed in the wearer's brain, thus forming a stereoscopic effect in the wearer's brain.

In addition, in order to further improve the stereoscopic display quality, the display frame frequency of the time division multiplexing polarization display device 400 may be at least twice an ordinary polarization display frame frequency. Thus, resolutions of the time division multiplexing polarization display device and the virtual reality head-mounted display device according to the present disclosure are doubled as compared with related existing stereoscopic display device in the case where the brightness is constant.

In the optical system of the virtual reality head-mounted display device as shown in FIG. 3 and FIG. 4, the display device is arranged on the side of the left eye. It will be appreciated by those skilled in the art that the display device may also be arranged on the side of the right eye. In this case, the optical length from the display device to the first imaging lens is likely larger than the optical length from the display device to the second imaging lens, and accordingly, the focal length of the first imaging lens may be greater than that of the second imaging lens. It will also be appreciated by those skilled in the art that the optical length from the display device to the first imaging lens may be equal to the optical length from the display device to the second imaging lens by arranging the optical part in FIG. 3 and FIG. 4, and accordingly, the focal length of the first imaging lens may be equal to that of the second imaging lens.

The specific arrangements of the present disclosure are described above by way of example. However, those skilled in the art should appreciate that the features, structures, or characteristics described above may be combined in one or more arrangements in any suitable manner. In the above description, numerous specific details are provided to fully understand the arrangements disclosed in this application. Those skilled in the art will appreciate that technical solutions disclosed in this application may be practiced without one or more specific details, or by using other methods, components, apparatus, steps, etc.

Finally, it should be noted that the above arrangements are merely intended to explain the technical solutions of the present disclosure rather than limiting the scope of the present disclosure. Although the present disclosure is described in detail with reference to some specific arrangements, those skilled in the art should understand that they may still make modifications or equivalent replacements to the technical solutions of the present disclosure without departing from the spirit and the scope of the technical solutions of the present disclosure. This application is intended to cover any variations, uses, or adaptations of the present disclosure following the general principles thereof and including such departures from the present disclosure as come within known or customary practice in the art. It is intended that the specification and arrangements be considered as example only, with a true scope and spirit of the present disclosure being indicated by the claims.

1-7. (canceled)

8. A virtual reality display device, comprising:
a display part configured to emit image light for forming an image from a light emission surface of the display part;
a polarization modulation part, arranged on the light emission surface of the display part, and configured to receive the image light emitted from the display part, and be controlled in a time division multiplexing manner to modulate the image light emitted from the display part to alternatively generate and emit at least two types of modulated light in a form of polarized light having different polarization directions, the at least two types of modulated light comprising first polarized light having a first polarization direction and second polarized light having a second polarization direction, the first polarization direction being different from the second polarization direction;
a polarization beam splitter configured to receive the modulated light emitted from the polarization modulation part, and allow the modulated light having the different polarization directions to emit from the polarization beam splitter along different light paths to form at least first path light and second path light; and
a first imaging lens and a second imaging lens, configured to respectively receive the first path light and the second path light, and alternately image the first path light and the second path light into a left eye and a right eye of a wearer wearing the virtual reality display device, respectively.

9. The virtual reality display device according to claim 8, wherein the optical system further comprises a reflecting part, the reflecting part is configured to receive and reflect one of the first path light and the second path light, such that reflected path light is parallel to the other one of the first path light and the second path light, and is incident on one of the first imaging lens and the second imaging lens.

10. The virtual reality display device according to claim 8, wherein an optical length from the display part to the first imaging lens is greater than an optical length from the display part to the second imaging lens and a focal length of the first imaging lens is greater than a focal length of the second imaging lens.

11. The virtual reality display device according to claim 10, wherein the optical length from the display part to the first imaging lens is equal to that from the display part to the second imaging lens, and the focal length of the first imaging lens is equal to that of the second imaging lens.

12. The virtual reality display device according to claim 10, wherein the optical length from the display part to the second imaging lens is larger than that from the display part to the first imaging lens, and the focal length of the second imaging lens is greater than that of the first imaging lens.

13. The virtual reality display device according to claim 8, wherein the display part is one of a liquid crystal display device and a liquid crystal on silicon display device, and the image light emitted from the display part is polarized light having the first polarization direction.

14. The virtual reality display device according to claim 13, wherein the polarization modulation part comprises a first transparent electrode and a second transparent electrode, and a liquid crystal layer sandwiched between the first transparent electrode and the second transparent electrode;
wherein the first transparent electrode is arranged on the light emission surface of the display part; and
wherein the polarization modulation part is configured to form one of the first polarized light having the first polarization direction and the second polarized light having the second polarization direction according to a fact whether a voltage is applied to the liquid crystal layer.

15. The virtual reality display device according to claim 8, wherein the display part is one of a plasma display device, an organic electroluminescence display device and a digital mirror device.

16. The virtual reality display device according to claim 15, wherein the polarization modulation part comprises a polarizer, a first transparent electrode arranged on the polarizer, a second transparent electrode, and a liquid crystal layer sandwiched between the first transparent electrode and the second transparent electrode;
wherein the polarizer is arranged on the light emission surface of the display part, and is configured to modulate the image light emitted from the light emission surface of the display part into the first polarized light having the first polarization direction; and
wherein the polarization modulation part is configured to form one of the first polarized light having the first polarization direction and the second polarized light having the second polarization direction according to a fact whether a voltage is applied to the liquid crystal layer.

17. A display device, comprising:
a display part configured to emit image light for forming an image from a light emission surface of the display part; and
a polarization modulation part, arranged on the light emission surface of the display part, and configured to receive the image light emitted from the display part, and be controlled in a time division multiplexing manner to modulate the image light emitted from the display part to generate at least two types of modulated light in a form of polarized light having different polarization directions.

18. The display device according to claim 17, wherein the display part is one of a liquid crystal display device and a liquid crystal on silicon display device, and the image light emitted from the display part is polarized light having a first polarization direction.

19. The display device according to claim 18, wherein the polarization modulation part comprises a first transparent electrode and a second transparent electrode, and a liquid crystal layer sandwiched between the first transparent electrode and the second transparent electrode;
wherein the first transparent electrode is arranged on the light emission surface of the display part; and
wherein the polarization modulation part is configured to form one of first modulated light having the first polarization direction and second modulated light having a second polarization direction according to a fact whether a voltage is applied to the liquid crystal layer, and the second polarization direction is different from the first polarization direction.

20. The display device according to claim 17, wherein the display part is one of a plasma display device, an organic electroluminescence display device and a digital mirror device.

21. The display device according to claim 20, wherein the polarization modulation part comprises a polarizer, a first transparent electrode arranged on the polarizer, a second transparent electrode, and a liquid crystal layer sandwiched between the first transparent electrode and the second transparent electrode;
wherein the polarizer is arranged on the light emission surface of the display part, and is configured to modulate the image light emitted from the light emission surface of the display part into first modulated light in the form of polarized light having a first polarization direction; and
wherein the polarization modulation part is configured to form one of the first modulated light having the first polarization direction and second modulated light having a second polarization direction according to a fact whether a voltage is applied to the liquid crystal layer, and the second polarization direction is different from the first polarization direction.

22. An optical system, comprising:
a display part configured to emit image light for forming an image from a light emission surface of the display part;
a polarization modulation part, arranged on the light emission surface of the display part, and configured to receive the image light emitted from the display part, and be controlled in a time division multiplexing manner to modulate the image light emitted from the display part to generate at least two types of modulated light in a form of polarized light having different polarization directions; and
a polarization beam splitter configured to receive the modulated light emitted from the polarization modulation part, and allow the modulated light having the different polarization directions to emit from the polarization beam splitter along different light paths to form at least first path light and second path light.

23. The optical system according to claim 22, further comprising a reflecting part,
wherein the reflecting part is able to receive and reflect one of the first path light and the second path light, such that reflected path light is parallel to the other one of the first path light and the second path light.
